(19) United States
(12) Patent Application Publication
(10) Pub. No.: US 2008/0184842 A1
(43) Pub. Date: Aug. 7, 2008

(54) Hand brake structure

(76) Inventor: Ya-Huei Sie, Hemei Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,083

(22) Filed: Oct. 31, 2007

(30) Foreign Application Priority Data
Feb. 1, 2007 (TW) 96201984

(51) Int. Cl. B62L 3/02

(52) U.S. Cl. 74/502.2

(57) ABSTRACT

This invention relates to an improved hand brake structure, in which a plurality of through holes are provided on the brake handlebar, a brake wire being provided within the brake handlebar, the end of the brake wire having several joints which are inserted and engaged in the through holes on the brake handlebar, only the joint located at the end of the brake wire abutting against one end of the through hole in proximity to the brake wire, while the rest of the joints abut against the other end of the through hole apart from the brake wire. In this manner, the joint located at the end of the brake wire begin to wear firstly in case of damage, and the joint nearest to the end of the brake wire fills the vacancy post in due order. Therefore, there is no need to replace a new brake wire in case of damage, and the safety of user can be ensured.

### BACKGROUND OF THE INVENTION

1. Field of the Invention

The present invention relates to an improved hand brake structure, particularly to an improved hand brake structure in which a plurality of through holes are provided on a brake handlebar, the end of a brake wire having several joints which are inserted and engaged in the through holes on the brake handlebar, and only the joint nearest to the end of the brake wire being fixed in the through hole. In this manner, the joint nearest to the end of the brake wire fills the vacancy in due order in case a damage is happened. Therefore, there is no need to replace a new brake wire in case damage is happened, and the safety of user can be ensured.

2. Brief Description of the Prior Art

Having good mobility, convenience and economical conformity, motorcycle has been so far the most popular traffic means in metropolitan area where the people suffer a traffic jam, lack of parking space. Concerning the action principle of motorcycle, the mixing gas of oil and air is inputted into the cylinder of an engine and is ignited to produce moving power by which the rear wheel is driven firstly, and then the front wheel is followed in synchronization with the rear wheel to move. Thus, the motorcycle can move forward. During the moving of the motorcycle, the action of the brake mechanism can be activated by the hand brake handlebar so as to stop the motorcycle. In the case of bicycle, the action of the brake mechanism can be activated by the hand brake handlebar so as to stop the bicycle.

As shown in FIGS. 5 and 6, the above hand brake structure has a brake handlebar (3) which is provided with a through hole (31). The brake handlebar (3) has a brake wire (4) disposed inside, one end of the brake wire (4) has a joint (41) inserted and engaged in the through hole (31) of the brake handlebar (3). The other end of the brake wire (4) is connected to the brake mechanism of a motorcycle or a bicycle.

However, the above hand brake has following defects in application.

(1) The location where the brake wire and joint connects together is often ruptured in case of the damage happened of the hand brake. The brake action will be disappeared after the rupture of the brake wire and the joint, so that a new brake wire and a new joint have to replace the ruptured ones. But it happens that the process of the replacement of a new brake wire and a new joint take much effort and time, such that the user is beset.

(2) If the hand brake is damaged during the driving of a motorcycle or a bicycle on the road, the whole brake structure will lose its function such that the driver might suffer the fatal danger.

There is another U.S. Pat. No. 7,219,573 B2 entitled “Gear-change control device for a bicycle” in which a hand brake is disclosed. In the above hand brake, a gear change control device for a bicycle having a handlebar with straight end portions, comprises a first control lever with a control portion arranged behind the end portion of the handlebar, with reference to the longitudinal direction of the bicycle, and extending at least partially at a position lying substantially at the same level of the handlebar, with respect to a vertical direction in the condition of use of the handlebar and a second control lever with a control portion arranged at the same level, below or upper the control portion of the first control lever.

However, the location where the sheaths and the threaded elements connect together is often ruptured in case of the damage happened to the hand brake. The brake action will be disappeared after the rupture of the sheaths and the threaded elements, so that new sheaths and the threaded elements have to replace the ruptured ones. But the process of the replacement of new parts takes much effort and time, such that the user is beset. If the hand brake is damaged during the driving of a motorcycle or a bicycle on the road, the whole brake structure will lose its function such that the driver might suffer the fatal danger.

### SUMMARY OF THE INVENTION

In view of the above defects, the inventor of the present invention provides an improved hand brake structure based on endless effort according to the abundant professional knowledge accumulated and the practical manufacturing experience in the relevant field, in which a plurality of through holes are provided on the brake handlebar, several joints being provided at the end of a brake wire, and only the joint nearest to the end of the brake wire being fixed in the through hole of the brake handlebar. In this manner, the joint nearest to the end of the brake wire fills the vacancy post in due order in case the damage of the joint is happened. Therefore, there is no need to replace a new brake wire in case damage is happened, and the safety of user can be ensured.

The improved hand brake structure of the present invention mainly has a brake handlebar, a plurality of through holes arranged in a straight line from one end to the other end of the brake handlebar are provided on the brake handlebar in such a manner that a suitable distance is maintained between two adjacent through holes, a brake wire being provided within the brake handlebar, the end of the brake wire having several joints which are inserted and engaged in the through holes on the brake handlebar, each joint being corresponding to each through hole such that a suitable distance is maintained between two adjacent joints, the cross sectional area of each joint being smaller than the area of each through hole in such manner that only the joint located at the end of the brake wire abuts against one end of the through hole in proximity to the brake wire, while the rest of the joints abut against the other end of the through holes apart from the brake wire. In this manner, the joint located at the end of the brake wire begin to wear firstly in case a damage is happened, and then the joint nearest to the end of the brake wire is then filled the vacancy post in due order. Therefore, there is no need to replace a new brake wire in case damage is happened, and the safety of user can be ensured.

### BRIEF DESCRIPTION OF THE DRAWINGS

The present invention will be better understood by the detailed description of the following preferred embodiments with reference to the accompanying drawings, in which:

FIG. 1 is a perspective exploded view showing the hand brake structure of the present invention.

FIG. 2 is a perspective assembled view showing the hand brake structure of the present invention.

FIG. 3 is a bottom view showing the hand brake structure of the present invention.

FIG. 4 is a bottom view showing the assembled structure after rupture of the hand brake structure of the present invention.

FIG. 5 is a perspective exploded view showing a prior art structure.

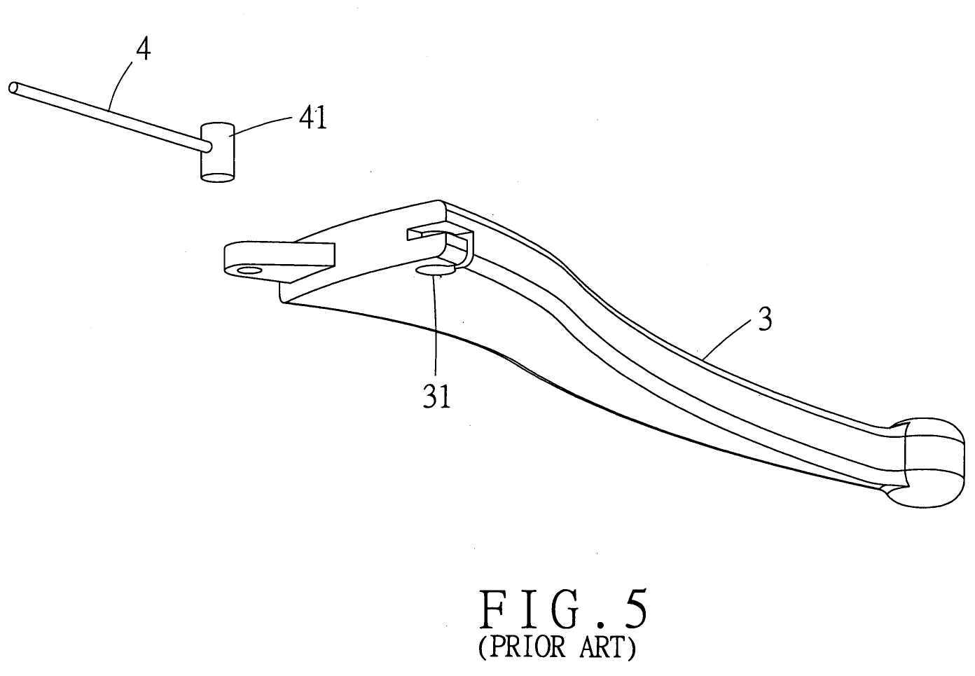

FIG. 6 is an assembled bottom view showing a prior art structure.

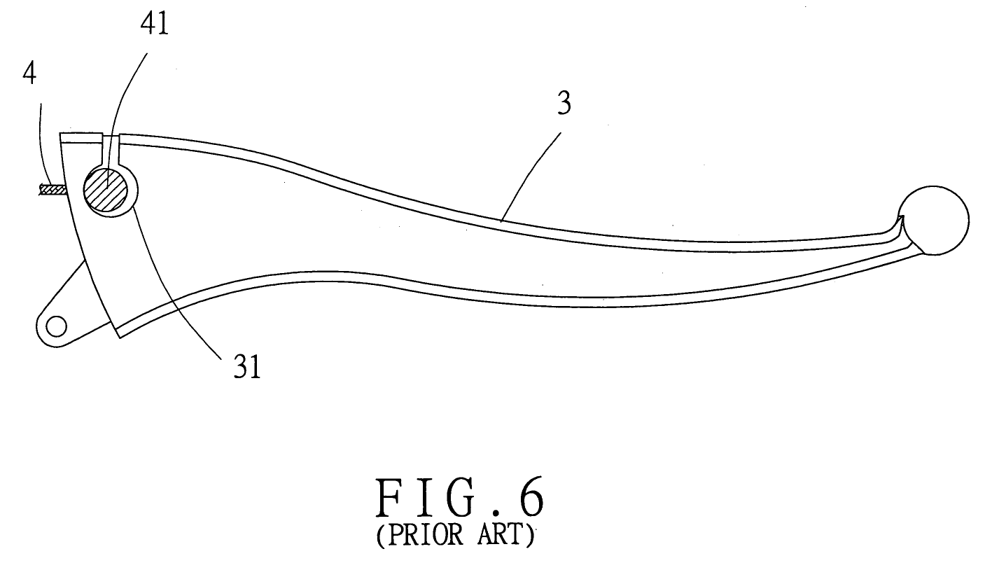

### DETAILED DESCRIPTION OF THE PREFERRED EMBODIMENTS

The technical contents of the present invention will become more apparent from the detailed description of the preferred embodiments in conjunction with the accompanying drawings.

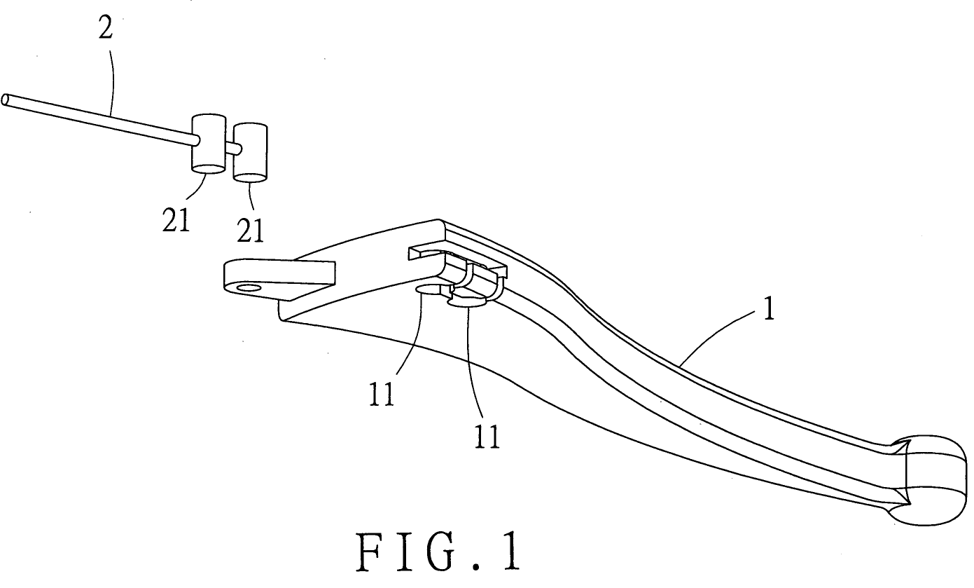

Firstly referring to FIG. 1, the improved hand brake structure of the present invention comprises a brake handlebar (1) and a brake wire (2), in which

a plurality of through holes (11) arranged in a straight line from one end to the other end of the brake handlebar (1) are provided in such a manner that a suitable distance is maintained between two adjacent through holes (11);

the end of the brake wire (2) has several joints (21), each joint (21) being corresponding to each through hole (11) such that a suitable distance is maintained between two adjacent joints (21), the cross sectional area of each joint (21) being smaller than the area of each through hole (11).

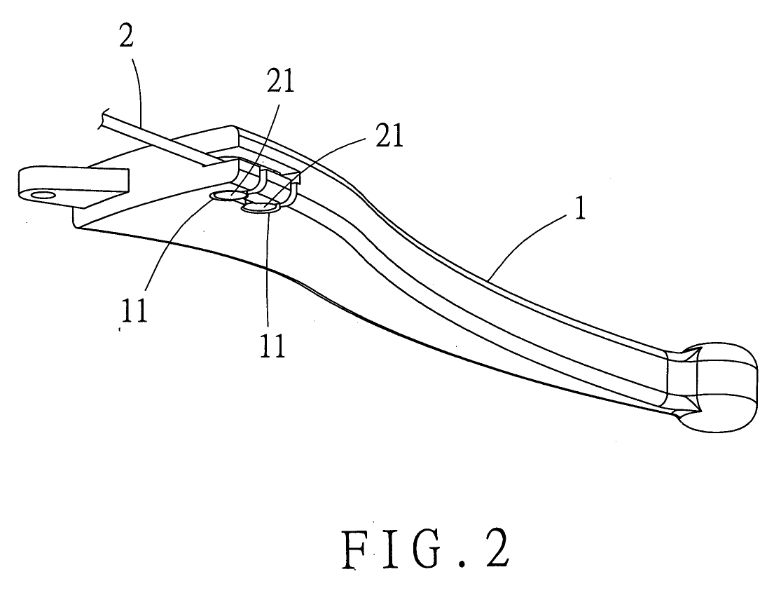

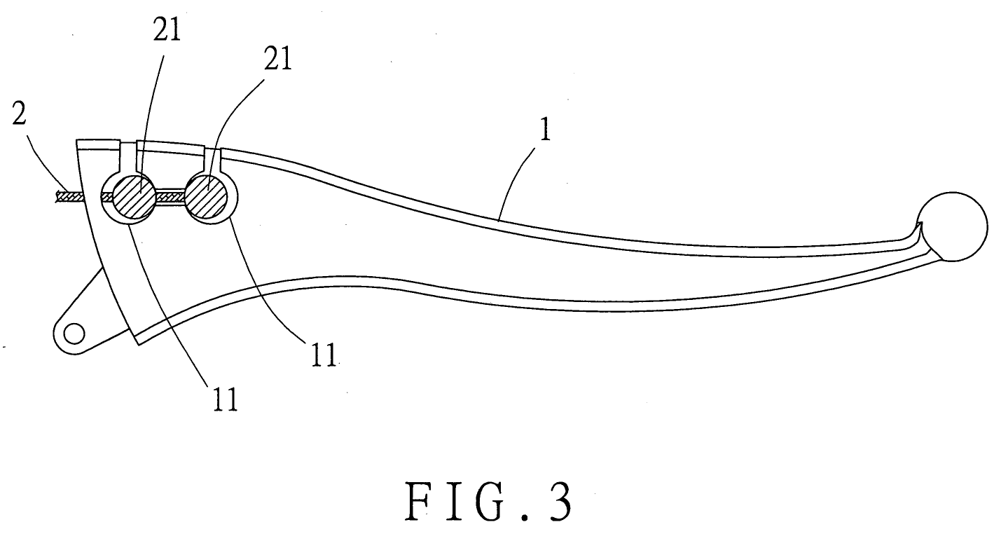

In assembling, as shown in FIGS. 2 and 3, the brake wire (2) is disposed into the interior of the brake handlebar (1) and the joints (21) are inserted respectively in the through holes (11) of the brake handlebar (1). As the cross sectional area of each joint (21) is smaller than the area of each through hole (11), only the joint (21) located at the end of the brake wire (2) abuts against one end of the through hole (21) in proximity to the brake wire (2), while the rest of the joints (21) abut against the other end of the through holes (11) apart from the brake wire (2). The other end of the brake wire (2) is connected to a brake mechanism of a motorcycle or a bicycle.

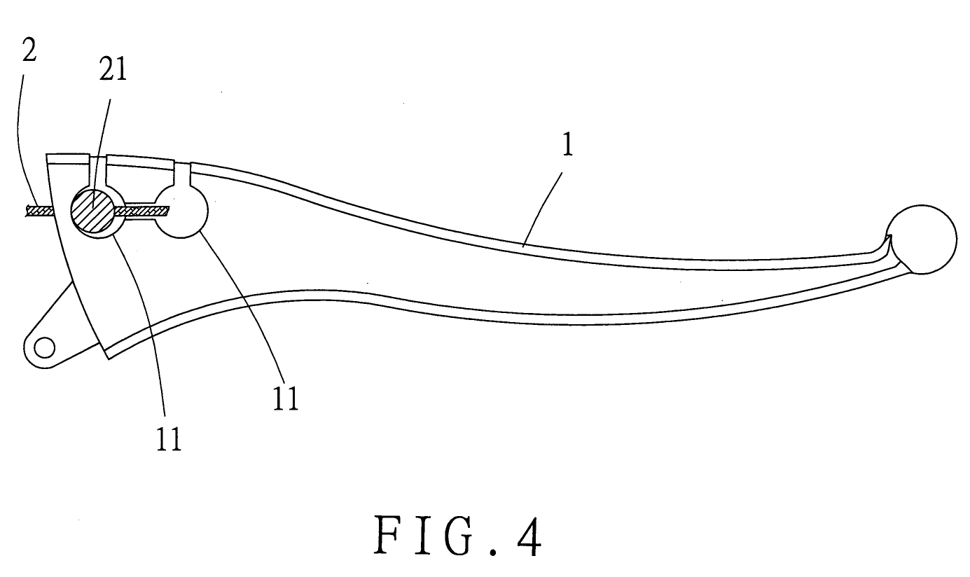

In applying brake, as shown in FIGS. 3 and 4, the joint (21) of the brake wire (2) is drawn by the through hole (11) of brake handlebar (1), and then the brake mechanism of the motorcycle or the bicycle is actuated by the brake wire (2). As only the joint (21) located at the end of the brake wire (2) abuts against one end of the through hole (21) in proximity to the brake wire (2), only the joint (21) located at the end of the brake wire (2) is drawn by the through hole (11) of brake handlebar (1) at each brake application. Thus, the rest of the joints (21) remain undamaged. If the joint (21) located at the end of the brake wire (2) is ruptured due to over-wearing, the joint (21) nearest to the end of the brake wire (2) among the rest abuts against the end of the through hole (11) in proximity to the brake wire (2), and is drawn by the through hole (11) of brake handlebar (1) at each brake application from now on. Accordingly, the joints (21) of the brake wire (2) will be worn in order from the joint (21) located at the end of the brake wire (2), and the joint (21) nearest to the end of the brake wire (2) fills the vacancy post in due order. Therefore, neither a need to replace a new brake wire (2) in case of damage is required, nor fatal danger of the driver will be happened in case the hand brake is damaged during the driving of a motorcycle or a bicycle on the road.

Based on the foregoing, this invention surely has the following advantages when comparing with prior art.
1. In this invention, a plurality of through holes are provided on the brake handlebar, and several joints are provided at the end of the brake wire. Only the joint at the end of the brake wire is damaged in case a rupture is happened, and then the joint nearest to the end of the brake wire fills the vacancy post in due order in case a rupture is happened. Therefore, there is no need to replace a new brake wire in case of damage such that convenience can be ensured in practical application.
2. Even the hand brake is damaged during the driving of a motorcycle or a bicycle on the road, the joint nearest to the end of the brake wire fills the vacancy post in due order such that the brake function of the whole hand brake structure remains unchanged. Therefore, there is no fatal danger of the driver.

Summing up above, the embodiment of this invention can reach expected effectiveness, and the specific configurations disclosed herein have yet not seen in the prior art of the same category of product, even has not been opened to the public before application.

While the present invention has been described with preferred embodiments in conjunction with the accompanying drawings, it is noted that the preferred embodiments and the drawings are purely for the convenience of description only, not intended to be restrictive on the scope of the present invention. Any modifications and variations or the equivalents brought out without departing from the spirit of the present invention is considered to be still within the scope of the present invention.

What is claimed is:

1. An improved hand brake structure, which mainly has a brake handlebar, a plurality of through holes, a brake wire being provided within the brake handlebar, the end of the brake wire having several joints which are inserted and engaged in the through holes on the brake handlebar, the cross sectional area of each joint being smaller than the area of each through hole in such manner that only the joint located at the end of the brake wire abuts against the one end of the through hole in proximity to the brake wire, while the rest of the joints abut against the other end of the through holes apart from the brake wire.

2. An improved hand brake structure as claimed in claim 1, wherein said plural through holes are arranged in a straight line from one end to the other end of the brake handlebar, and a suitable distance is maintained between two adjacent through holes.

3. An improved hand brake structure as claimed in claim 2, wherein each joint is corresponding to each through hole such that a suitable distance is maintained between two adjacent joints,
